(19) United States
(12) Patent Application Publication
(10) Pub. No.: US 2002/0186998 A1
(43) Pub. Date: Dec. 12, 2002

(54) Clamping device for an elbow connector

(76) Inventors: Chang Hui Chen, Taipei City (TW); Tsun Wu Liao, Taipei City (TW)

Correspondence Address: Chang Hui CHEN, PO Box 82-144, TAIPEI, TW

(21) Appl. No.: 09/875,868

(22) Filed: Jun. 8, 2001

(51) Int. Cl. F16D 1/12; F16D 3/00; F16C 11/00

(52) U.S. Cl. 403/97

(57) ABSTRACT

A clamping device, for elbow connection having adjustable angle comprising a main body tube seat which can be locked onto a tube and a rotating toothed locking device of an elbow connector, characterizing that a lateral side of the tube seat is connected with a protruded L-shaped board seat, having a through hole at the center thereof. The internal side of the through hole of the protruded L-shaped board seat is provided with a toothed surface arranged in the circular manner and the external side of the clamping element of the locking device is provided with a matching toothed surface for engagement with that of the board seat to position. When the locking nut is released, the locking device can be changed so as to rotate the elbow connector to a desired angle.

### BACKGROUND OF THE INVENTION

(a) Field of the Invention

The present invention relates to a clamping device for an elbow connector and in particular, a clamping device having a main tube seat provided with an L-shaped board seat having a tooth-like surface to engage with another tooth-like surface of a locking seat.

(b) Description of the Prior Art

There are a plurality of tube connectors being exploited to mount various type of tubes and fittings. Most of them are made in a fixed T shape for horizontal and vertical connection, thus not able to allow for angle adjusting. There are applications when angle adjustments between the vertical and horizontal connection are needed to achieve the the desired effects, such as in lighting and broadcasting situations.

Most conventional stands or fixtures for the above-mentioned purposes are so made that they can only stand upright on the floor. They take up too much floor space and their tripods can also be very obtrusive. As a result, the angle of some of these devices need to be adjusted in order to provide a most appropriate effect. Due to the lack of adjustable structure, it always takes time to arrange and adjust the devices when they are needed. Thus, it is an object of the present invention to provide a clipping device for an elbow connector which mitigates the drawbacks of the conventional clamping device.

### SUMMARY OF THE INVENTION

Accordingly, it is an objective of the present invention to provide a clamping device for elbow connection with angle adjustability, comprising a main body tube seat which can be locked onto a tube and a rotating toothed locking device of an elbow connector, characterizing that a lateral side of the tube seat is connected with a protruded L-shaped board seat, having a through hole at the center thereof. The internal side of the through hole of the protruded L-shaped board seat is provided with a toothed surface arranged in the circular manner and the external side of the clamping element of the locking device is provided with a matching toothed surface for engagement with that of the board seat to position. When the locking nut is released, the locking device can be changed so as to rotate the elbow connector to a desired angle.

The foregoing objective and summary provide only a brief introduction to the present invention. To fully appreciate these and other objectives of the present invention as well as the invention itself, all of which will become apparent to those skilled in the art, the following detailed description of the invention and the claims should be read in conjunction with the accompanying drawings. Throughout the specification and drawings, the same reference numerals refer to identical or similar parts.

Many other merits and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the combination of the present invention.

FIG. 3 is a reference view of a preferred embodiment of the present invention, showing it upholding a cymbal holder.

FIG. 4 is a reference view of the preferred embodiment of the present invention, showing the combination being rotated to a different angle.

FIG. 5 is a schematic view of the present invention, showing its upholding a microphone holder.

### DETAILED DESCRIPTION OF THE PRESENT INVENTION

For the purpose of promoting the understanding of the principles of the invention, reference will now be made to the embodiment illustrated in the drawings. Specific language will be used to describe same. It will, nevertheless, be understood that no limitation of the scope of the invention is thereby intended. Alterations and further modifications in the illustrated device, and further applications of the principles of the invention as illustrated herein are contemplated as would normally occur to one skilled in the art to which the invention relates.

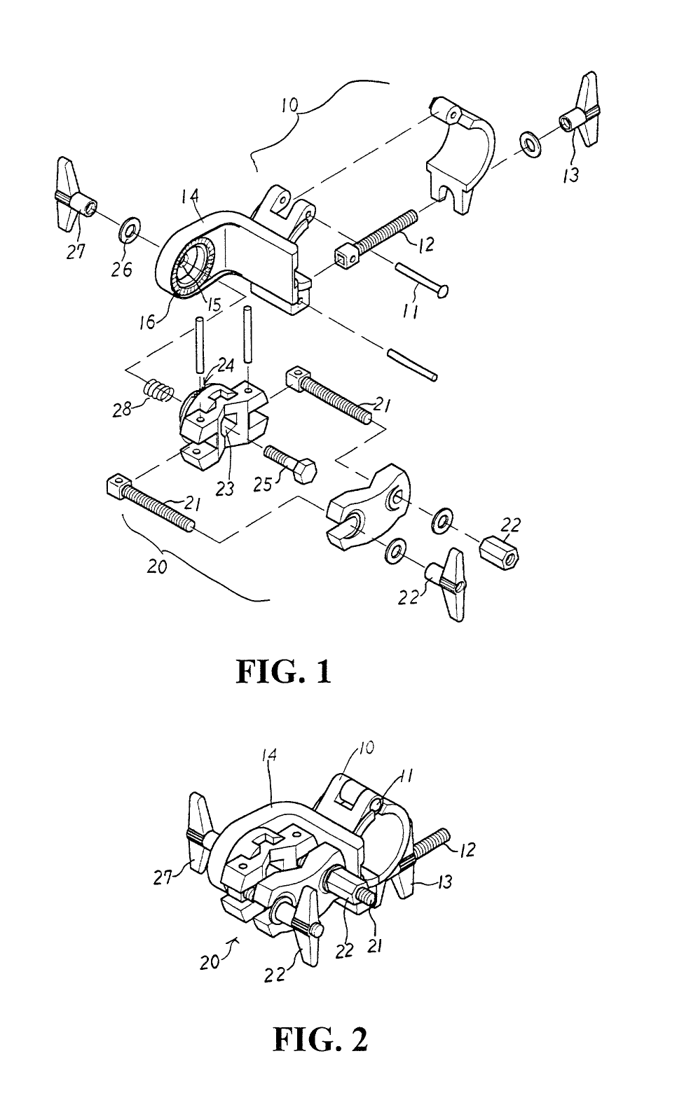

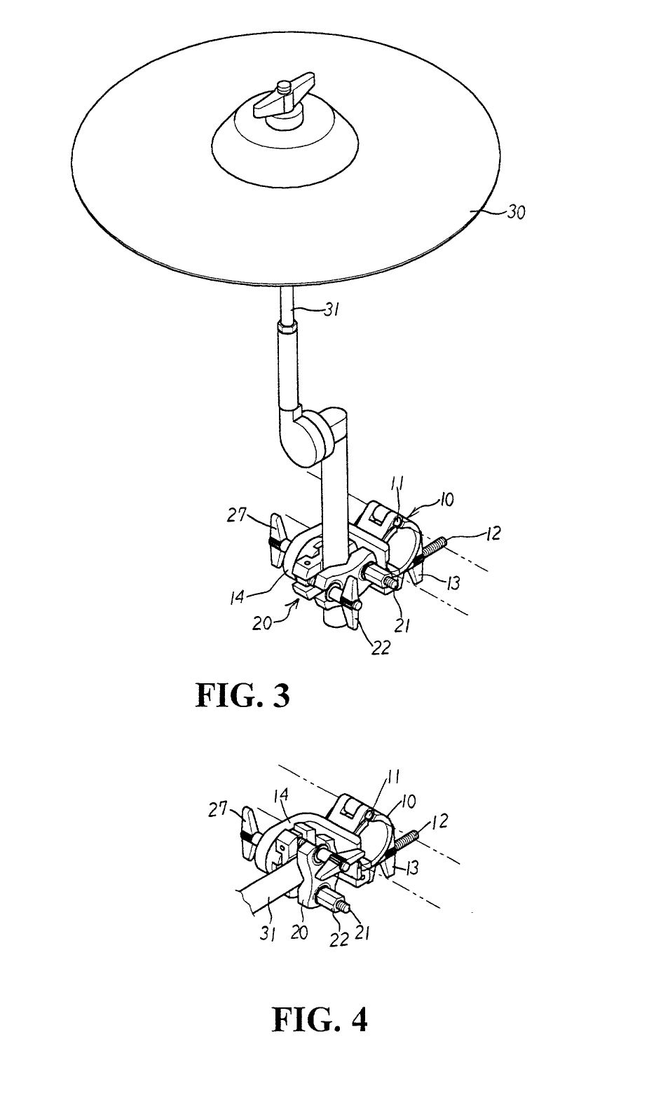

Referring to FIGS. 1 to 5, there is shown a clamping device for an elbow connection which is angle adjustable, comprising a main body tube seat 10, for direct mounting onto a shaft or tubular frame, the tube seat 10 being formed from two half tubular elements in combination with a shaft 11, a locking screw rod 12 and a locking nut 13. The external side of a half tubular surface is in combination with an L-shaped board seat 14 with a center through hole 15. The internal side of the through hole 15 is provided with a toothed surface 16. A clamping member 20 for locking connection can be made into any shape such as circular; or square in combination with the screw rod 21 and the locking nut 22, the clamping member 20 can be used to securely hold any tube or shaft of matching shape. One half of the clamping member is provided with a through hole 23 whose external side is provided with a toothed surface 24 to match that on the board seat 14 so as to form into a tooth-like engagement. In combination with a direct mounting peg 25 passing through the two tooth-like surfaces 16 and 24, a pad 26 and a screw nut 27, a complete locking element is formed. An elastic pad 28, normally, a spring, can be positioned therein between so that it can facilitate the separation and direction adjustment of the two tooth-like surfaces 16 and 24. The locking nuts 13, 22, 27 can be made into a butterfly-shaped to facilitate manual operation.

In connection with the present invention, one side of the main body tube seat 10 is provided with an L-shaped board seat protruded therefrom, and the internal side, surrounding the through hole 15 of the board seat 14, is provided with a tooth-like surface 16. When in combination of the clamping device 20 by means of the corresponding tooth-like surface 24, the mounting peg 25 is used as a pivoting shaft by the clamping device 20 and the board seat 14 for adjustment.

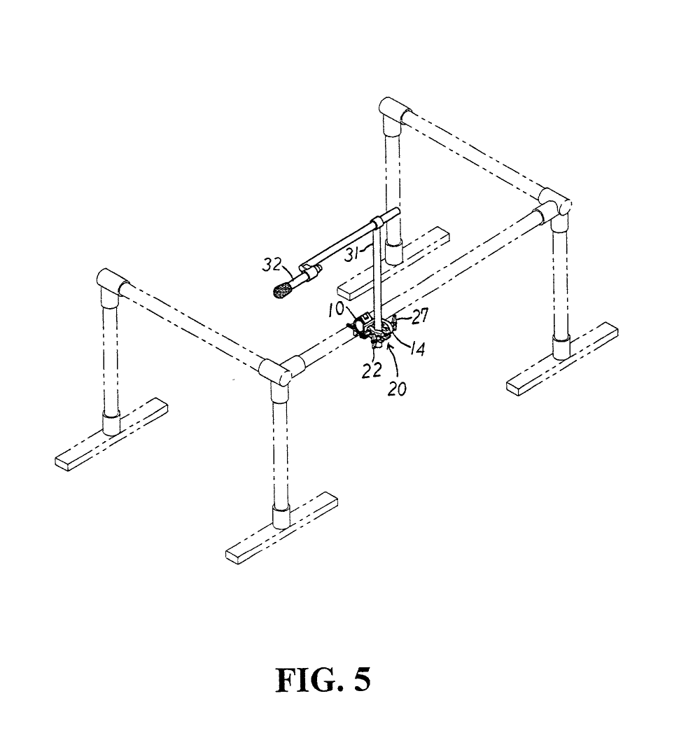

FIGS. 4 and 5 show the mounting of a cymbal holder and a microphone 32. For the drummer to hit the cymbal, etc. at the best angle, there's the need to adjust the position of the said instrument. Similarly, for an illumination device or the microphone 32, the present invention allows the support rod 31 held up by the clamping device 20 to be adjusted by rotating the clamping device 20 to the desired angle after releasing and ro-locking the peg member 25 in combination with the screw nut 27.

In view of the above structure of the present invention, and with the combination of the tooth-like surface, the angle of the clamping device can be adjusted.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A clamping device, for elbow connection having adjustable angle comprising a main body tube seat which can be locked onto a tube and a rotating toothed locking device of an elbow connector, characterized in that:
a lateral side of the tube seat is connected with a protruded L-shaped board seat, having a through hole at the center thereof. The internal side of the through hole of the protruded L-shaped board seat is provided with a toothed surface arranged in the circular manner and the external side of the clamping element of the locking device is provided with a matching toothed surface for engagement with that of the board seat to position. When the locking nut is released, the locking device can be changed so as to rotate the elbow connector to a desired angle.

2. A clamping device for elbow connector as set forth in claim 1, wherein an elastic element can be positioned between the toothed surfaces to supplement separation when the locking is released.

3. A clamping device for elbow connector as set forth in claim 1, wherein the locking nut can be made into a “butterfly” shaped nut allowing easy operation.
